(19) United States
(12) Patent Application Publication
(10) Pub. No.: US 2010/0198614 A1
(43) Pub. Date: Aug. 5, 2010

(54) MEDICAL COMMUNICATION SYSTEM FOR HEALTH CARE PRACTITIONERS

(75) Inventors: Vineet Chopra, Ann Arbor, MI (US); Prasanth Gogineni, Ann Arbor, MI (US); Shuang Zhao, Ann Arbor, MI (US); Marc Alan Schweikert, Otsego, MI (US); Bret Jared Abel, Grand Haven, MI (US); Stephen Gregory Metz, Ann Arbor, MI (US)

Correspondence Address: JAMES D. STEVENS;REISING ETHINGTON P.C., P.O. BOX 4390, TROY, MI, 48099, US

(73) Assignee: THE REGENTS OF THE UNIVERSITY OF MICHIGAN, Ann Arbor, MI (US)

(21) Appl. No.: 12/697,782

(22) Filed: Feb. 1, 2010

Related U.S. Application Data
(60) Provisional application No. 61/148,783, filed on Jan. 30, 2009.

(51) Int. Cl. G06Q 10/00; G06Q 50/00; G06F 17/30; H04W 88/02

(52) U.S. Cl. 705/2; 707/802; 455/550.1; 707/E17.044

(57) ABSTRACT

A medical communication system for use in connection with providing medical care to patients at a health care facility. The system includes a central server, a database accessible by the server, and a plurality of mobile stations each carried by a health care practitioner for use within the facility. Each of the mobile stations are accessible within the health care facility by the server via wireless communication. The database provides storage of task information associated with patients receiving medical care at the facility, wherein the task information comprises information associated with a task, including identification of the task, task status, task priority, task assignment or any combination of these. Task information can be shared and updated on each of the mobile devices of the practitioner associated with the patient.

### CROSS-REFERENCE TO RELATED APPLICATION

This application claims the benefit of U.S. Provisional Application No. 61/148,783, filed Jan. 30, 2009, the complete disclosure of which is hereby incorporated by reference.

### TECHNICAL FIELD

This invention relates to computer-based systems for communicating patient medical information among health care practitioners.

### BACKGROUND OF THE INVENTION

Studies have demonstrated that significant time is lost by clinicians performing non-urgent tasks during clinical, patient-care hours. These tasks may involve non-urgent clinical work such as addressing borderline lab anomalies or acknowledging non-urgent messages, and/or non-clinical work such as administrative functions and non-urgent computer order entry. These patient related activities frequently interrupt the physician's workflow and train of thought and can thus interfere with the delivery of care to the patient at the bedside.

During a typical eight hour shift, physicians may receive anywhere from 30 to 80 paged messages, many of which contain call back numbers without any further information. Given the large quantity of incoming pages and the relative inability to prioritize and/or interpret urgent from non-urgent messages, health care providers are frequently distracted from the task at hand to deal with what are often less pressing issues. In addition, the delivery of care to the patient either in a hospital or clinic setting typically involves members of a medical team, comprising various individuals such as physicians, residents, medical students, physician assistants, and nurses, and various support services such as laboratory and food services as well as medical specialty services such as radiology. Communication among these entities is essential to safe and timely health care. For this reason, various technologies have been employed with varying success in the healthcare setting, including cellular phones and pagers, and network environments that enable order entry, access to patient records, and review of laboratory and test results.

While cellular technology promises immediate voice connectivity and paging systems provide reliability, these technologies are usually limited in their current mode of employment to the purposes of message delivery/notification and direct person-to-person communication. Thus, a typical hospital use of pagers might involve short alphanumeric messages sent to pagers from desktop workstations located on each floor. This unimodal form of delivery is characterized by an inability to sort priority as all messages are delivered with the same customary tone or vibratory alert. As messages vary from the very mundane to life threatening emergencies, responsible care-givers are constrained to attend to every beeping chirp with the same urgency. This creates beeper fatigue and can reduce response times towards messages. Further, most messaging systems are limited in text/character length, necessitating a phone call should the message recipient remain unclear or need to follow up on a particular aspect of that message. Also, with the increasing size of hospitals and increasing patient volumes, most caretakers are rarely in the same place at the same time. Thus, owing to the point-to-point nature of paging systems, it is nearly impossible to ensure that every member of the team remains aware of task assignments and prioritization unless individual messages are sent to each member. This problem is compounded by the staggered shift-based system of inpatient care, a model characterized by the schematic “handing off” of patient care to a unique set of caretakers every 8-12 hours.

### SUMMARY OF THE INVENTION

In accordance with one aspect of the invention, there is provided a medical communication system for use in connection with providing medical care to patients at a health care facility. The system includes a central server, a database accessible by the server, and a plurality of mobile stations each carried by a health care practitioner for use within the facility. Each of the mobile stations are accessible within the health care facility by the server via wireless communication. The database provides storage of task information associated with patients receiving medical care at the facility, wherein the task information comprises information associated with a task, including identification of the task, task status, task priority, task assignment or any combination of these. The server is operable, for any particular patient, to access task information associated with that patient from the database and send the task information to mobile stations carried by the health care practitioners associated with that patient. The server is further operable to receive task information from one of the health care practitioners via one of the mobile stations, store the received task information in the database, and provide the received task information to the mobile stations of other health care practitioners associated with that patient, whereby the mobile station of each practitioner associated with that patient can be automatically updated with new task information for the patient.

In accordance with another aspect of the invention, there is provided a mobile station for use in a medical communication system such as the one described herein. The mobile station comprises a mobile handset that includes a display and a program stored on the handset. The program is operable upon execution to enable the receipt of task information, patient information, and messages from a server, and to present the received information and messages on the display in response to user interaction with the handset. The program is further operable to identify a priority associated with received messages and signal arrival of each received message in a manner that depends on its priority.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a block diagram of a medical communication system constructed in accordance with the invention;

FIG. 2 is a block diagram of information flows between users carrying the mobile stations, care-providers at the computer stations, and the other secondary medical systems;

FIG. 3 depicts a hierarchical, workflow-based view of typical actions that different sorts of users of the system of FIG. 1 may perform;

FIG. 4 depicts the workflow that can be implemented on the mobile stations and other client devices of FIG. 1;

FIG. 5 shows the states and transitions between states for the tasks;

FIGS. 6-7 depict exemplary user interfaces that can be used by the computer stations or other client devices of the system of FIG. 1;

FIGS. 8A-8H show various user interfaces used in the mobile stations of the system of FIG. 1;

FIG. 9 is a block diagram showing some of the software architecture and protocols used in the system of FIG. 1;

FIG. 10 depicts some of the web service functions used by the client devices to obtain patient and task information from the server of FIG. 1;

FIG. 11 depicts the class diagram used in the system of FIG. 1; and

FIG. 12 shows the database schema used in the system of FIG. 1.

### DETAILED DESCRIPTION OF THE PREFERRED EMBODIMENTS

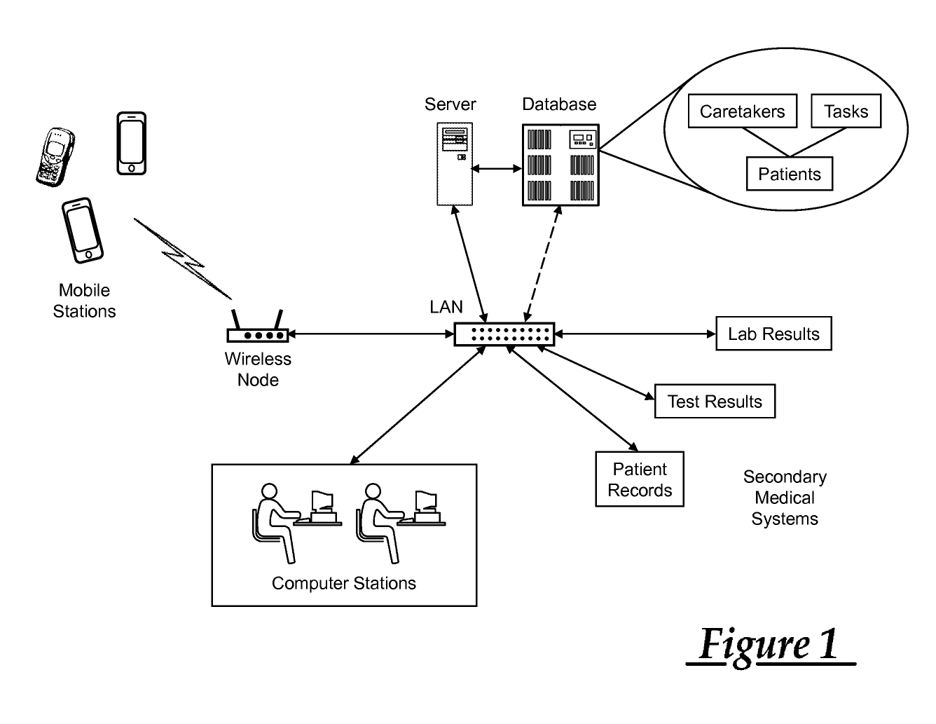

Referring to FIG. 1, there is shown a block diagram of the basic components of a medical communication system for use in connection with providing medical care to patients at a health care facility such as a hospital or clinic. These facilities commonly contain existing computer-based systems to record, distribute, and store patient medical information. Some of these secondary medical systems are shown in FIG. 1. They include a lab results system, a test results system and a patient records system, all of which can be accessed via computers throughout the facility. Each of these secondary medical systems are usually a separate hardware/software combination that are interlinked together via a local area network (LAN) in the facility, or may be combined either partially or fully into one or more integrated systems.

In general, the lab results system represents computer-based storage and reporting of laboratory results for parameters such as blood or body fluid analysis. The test results system represents computer-based storage and reporting of specific medical testing for such things as radiology and other medical imaging (an example of one such system is a picture archiving and communication system—PACS). The patient record system stores electronic medical records and key clinical and/or demographic patient information. The computer stations provide access to the information supplied by these other systems. In addition, the computer stations can also provide electronic physician order entry capabilities such that specific tests may be ordered directly from any one of these stations. Other medical service systems such as pharmacy services are not shown, but could be included and are frequently integrated as well.

At the heart of the medical communication system is a data-server that manages communication with the mobile stations carried by the health care practitioners in that facility. The data-server is used as a communication pathway between each of the mobile stations and the other devices within the system. Its primary functions are to (a) create, store and manage common task lists associated with patients and (b) manage communication between the mobile stations themselves and between each mobile station, computer station, and secondary medical system. As will be discussed in further detail, the common task list associated with a patient is managed dynamically by the server. This is then relayed to the computer stations and mobile stations carried/used by the members of the medical care team associated with that patient. For example, in one embodiment, the task list and changes made to it are pushed from the server to the mobile stations but, for the computer stations, are pulled from the server (e.g., incorporated into a webpage) only when accessed by a computer station. This dynamic system allows for individual team members to have access to the common task list, with changes made by one practitioner being instantaneously updated at least on the mobile stations of other team members.

Similarly, communication via pages and/or other messages (such as instant or text messages) to mobile stations can be tagged with a priority that is then interpreted by the mobile station in signaling the arrival of the new message. This allows for differential message alerts and signaling, based on message priorities, such as urgent or non-urgent. This feature helps avoid interruption of the physician who may be in the midst of delivering patient care or involved in some other more important task.

Also, both the tasks and associated messaging between providers are archived and stored at the server and remain accessible to all caregivers associated with the patient. Such a centralized management and supply of information helps increase communication between practitioners and adds a new layer that helps ensure that no information is lost when, for example, the patient is handed off from the daytime care teams to the night staff.

The common task list for each patient comprises a collection of tasks generated by the attending physician (physician in charge) and/or other health care practitioners on the care team. Tasks represent work assignments that can, but need not have an associated priority. The common task list can be initiated in response to admission of a patient to a health care facility or upon assignment of the patient to a unit or floor of the facility. Certain standardized tasks can be routinely added to a common task list, such as placing the patient on a specific diet upon admission. These tasks remain virtually limitless and (at the discretion of the ordering physician) can range from ordering diets to physical therapy to chest x-rays to blood work, etc. Certain tasks may be routinely generated automatically by the system based on patient information, lab results, or other parameters. For example, upon adding an order for a chest x-ray, the system can automatically schedule a follow-up task to help ensure that, once available, a reminder is issued to review the results by the physician. As another example, upon receiving an abnormal lab value the system can automatically send an alert and/or schedule one or more additional tests that show up on the common task list for the patient, with the physician then having the ultimate ability to approve, modify or cancel the automatically-generated response.

Initially, when a new task is added to a patient's common task list, it accessible as a part of the common task list via each of the computer stations, and it is sent to all mobile stations of the team members assigned to that patient. Thereafter, changes relating to that task (e.g., updated status information) can be sent to each mobile station as these occur in a dynamic fashion. All such information sent between devices in the communication system of FIG. 1 is referred to herein as task information, which includes the task itself (e.g., an identification of the task), task status (e.g., acknowledged or completed), task priority (e.g., urgent or non-urgent), task assignment (e.g. physician, nurse or student), or any other relevant field and/or any combination of these. Task information can also include any other attributes or properties relating to the task, such as a time or range of time when the task is to be carried out, notes associated with the task, billing information, etc. When adding a task to a patient's common task list or updating information for an existing task, this new information may be added on the mobile stations and computer stations by sending only that specific task information, or the entire updated common task list can be re-supplied to the different mobile and nursing stations. This latter approach may be beneficial, for example, in instances where the server uses a web-page approach to delivering content to the mobile stations and/or computer stations.

All task information is maintained in a database at the server, as shown in FIG. 1. This data server could be located elsewhere and be separately connected to the network. However implemented, the database is accessible by the server for storage and retrieval of not only the task information, but also the associated patient and caretaker information. Furthermore, messaging (pages, notifications, etc.) to and from the mobile stations and computer stations, (or even the secondary medical systems, if desired), are carried out via the server such that the messages are stored in the database in association with the patient to which they apply. By virtue of this storage property, these remain retrievable by all members of the care team. These messages as well as the tasks can be archived in the database once they are complete and no longer generally needed. This can occur, for example, a certain amount of time after the message was sent and/or the task was marked as complete, or upon discharge of the patient.

Further, tasks can be maintained indefinitely on the task list until the entire list is archived. Conversely, individual tasks can be removed and archived as they no longer are needed. This archiving can be initiated manually by one of the team members or administrators, or can be programmed to occur automatically, such as in response to patient discharge.

The mobile stations themselves may be any portable electronic device that has wireless communication capabilities and a display for presenting the task list, patient information, and other related information. As one example, the mobile stations may be a cellular handset that includes cellular communication capability as well as wireless local area networking capability (WLAN). This would enable to handset to be used for regular telephony via cellular communication over a wireless carrier system, such as one using 2G CDMA (IS-95), 3G CDMA2000 (IS-2000, 1×RTT, EVDO), 3G UTMS (W-CDMA, HSPA), or 2G/2.5G GSM (GPRS and EDGE), or other similar systems. This would also allow such devices to be used for communication within the health care facility with the server via a wireless node on the LAN. For this latter purpose, any suitable communication technology can be used, such as IEEE 802.11 protocols, Wi-Fi, WiMAX, WLAN or Bluetooth.

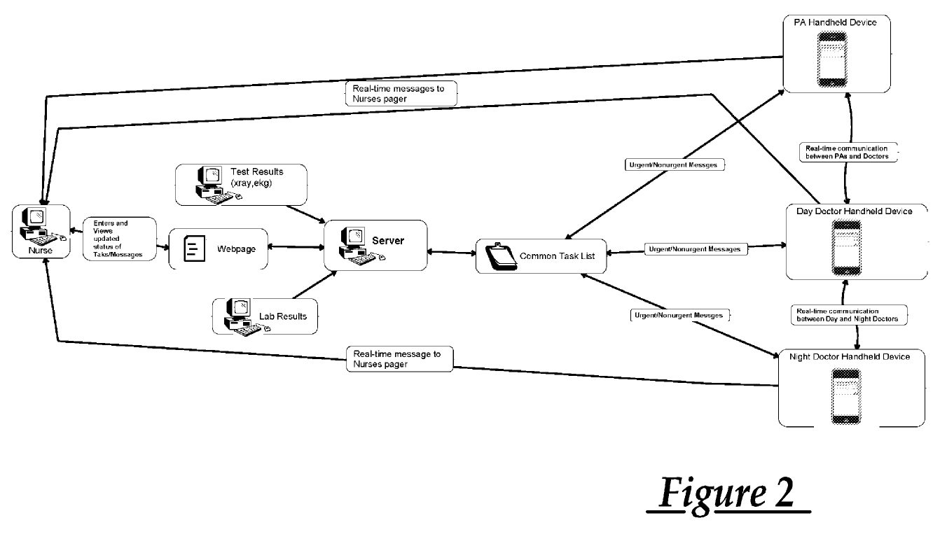

Referring now to FIGS. 2-5, the use and workflow of the system will be described. FIG. 2 depicts the basic information flows between users carrying the mobile stations, care-providers at the computer stations, and the other secondary medical systems. In general, physicians (which may include attending physicians or residents) and/or physician assistants each carry a mobile stations with them. If desired, other caregivers such as nurse practitioners, nurses, and/or medical students can also be given mobile stations to use with the system. As discussed above, these mobile stations connect to the server and provide the health care practitioner with the common task list for each patient associated with that practitioner or medical team. They also permit enhanced paging and communication through the server as mentioned above.

In general, nurses are provided secure access to a website on the server via computer stations on the hospital/clinic floors. Other users can also have access to the system via the website, but may also have the option to access it through mobile stations. This website lists each patient and displays the patient's associated task list. The central server is then responsible for transferring task information and communication back and forth between physician, nurses, and other care-givers in real time. Thus, in daily operation as shown in FIG. 2, task information and associated messages of either an urgent or non-urgent nature are sent between the server and the mobile stations using variable alerts (audible ringtones, vibratory alerts, etc.), based on the priority of the message. These messages can originate from anyone via the website, from one of the secondary medical systems (e.g., for retrieved data such as PSL, meds, orders, etc.), or from one of the mobile stations. As an example, a nurse reviewing lab results can send a specific message to the physician reporting an abnormal lab result and can identify the message as urgent if action is required within a short amount of time (e.g., immediately or within 30 minutes). As another example, the lab results system could automatically send an urgent message to the physician or nurse upon completion of lab work ordered as “Stat” or results that represent abnormal values. Although the message flows shown in FIG. 2 depict some as being direct between mobile stations, or between a mobile station and the computer station, it will be appreciated that these messages can be routed via the server for managing priority and storage of the messages.

Message recipients may save a message for later, reply with questions, or mark a message as acknowledged or complete. When a message responded to in any way (acknowledged, completed, etc.), all caretakers for that patient can see this immediately. This allows for total transparency for how tasks have been handled, which tasks have been done, by whom and at what time.

All messages are transmitted securely, to comply with HIPAA (Health Insurance Portability and Accountability Act) regulations. This is accomplished via using any number of encrypted or other secure transmission technologies, such as secure socket layers and/or certified digital certificates. In addition, sensitive data stored in the database can be encrypted as well. Such techniques for secure transmission and storage of information are known to those skilled in the art.

An advantage of the common task list and centralized messaging aspect is that it can greatly simplify patient handoff methodologies between care teams or between individual members of a team. For example, as indicated in FIG. 2, most inpatients in a modern day facility are cared for by day or night-time care teams comprising both physician and nursing staff. With the increasing complexity of inpatient care, it is helpful to transparently share all patient status and task information between these entities. By maintaining the common task list on the server, along with the history of messages and communications about that patient, a handoff of patient responsibility between the two doctors or between two nurses (or any combination of the healthcare team) can be more completely and efficiently accomplished in a manner that can help prevent medical errors. The system achieves this by having caretakers associate themselves with a patient (as physician, nurse, etc.), at which point that patient's common task list becomes accessible to the caretakers, either via the computer station or the mobile station carried by the practitioners. This assignment of the caretaker may be done manually or maybe automated based on the caretakers schedule. Thus, all tasks—completed and outstanding—and all associated patient information immediately becomes available to the physician or nurse assuming care for that patient.

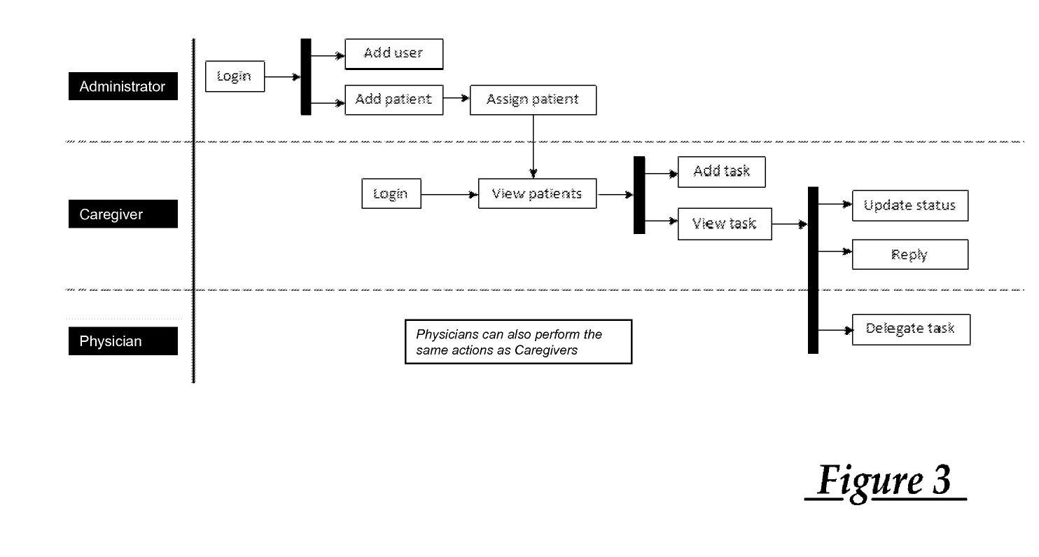

Management of the system can be carried out by an administrator who can be, for example, a hospital staff administrator or can be a caretaker such as a physician. FIG. 3 shows the typical actions that different sorts of users may perform. Administrators log into the server via the website or a special administrator's page of the site, which allows them to manage the system users and patients. An administrator's most common tasks include adding new users and patients to the system. Administrators may also assign a patient to a particular user; this will allow the user to view that patient's task list and add new tasks for the patient. Typically, the administrator does not directly deal with the creation or managing of tasks, although as discussed above certain initial tasks can be assigned upon setting up a new patient in the system. The adding of patients, caregivers, users to the system maybe automated by pulling this data from other systems within the hospital/healthcare setting.

Caregivers (including physicians) log in to the website via a page displayed on their computer station or mobile station that gives them access to managing tasks and sending messages. They first see a list of patients associated with them, based on the associations made by the administrator. For each patient, practitioners can view the patient's existing tasks or create a new task for the patient. When viewing a patient's existing tasks, the caregiver has the ability to update the task's status or “reply” to the task. Replying to a task causes a message to be sent to the original creator of the task to request additional details or clarification, whereupon the creator can reply back with the requested information. As shown in FIG. 3, physicians retain all of the functionality of caregivers and/or administrators. In addition, they also possess the ability to delegate an active task to another user. When a task is delegated to a user, a message is sent to the user informing them of this delegation. Additionally, tasks may be delegated to other caretakers by a physician.

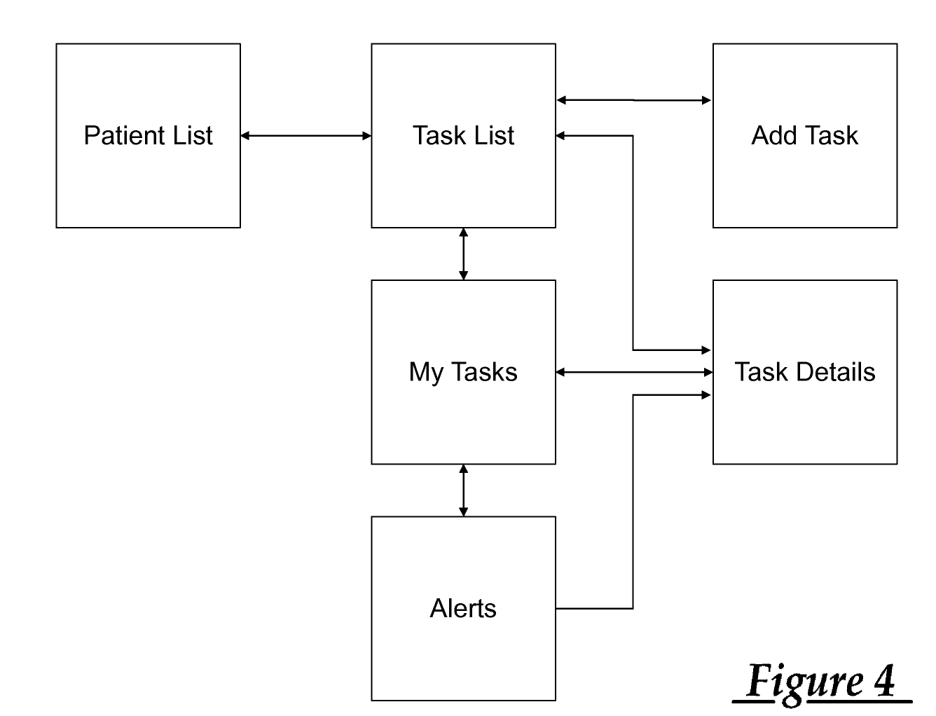

FIG. 4 depicts the workflow that can be implemented on the client devices (i.e., the mobile stations and computer stations). This workflow can be carried out using an application installed on the client or via logic at the server using a website interface, or a combination of both. For example, the mobile stations can utilize an application installed on the handset to carry out this workflow and the associated functions, whereas the computer stations in the facility can access a website on the server that implements the workflow and associated functions.

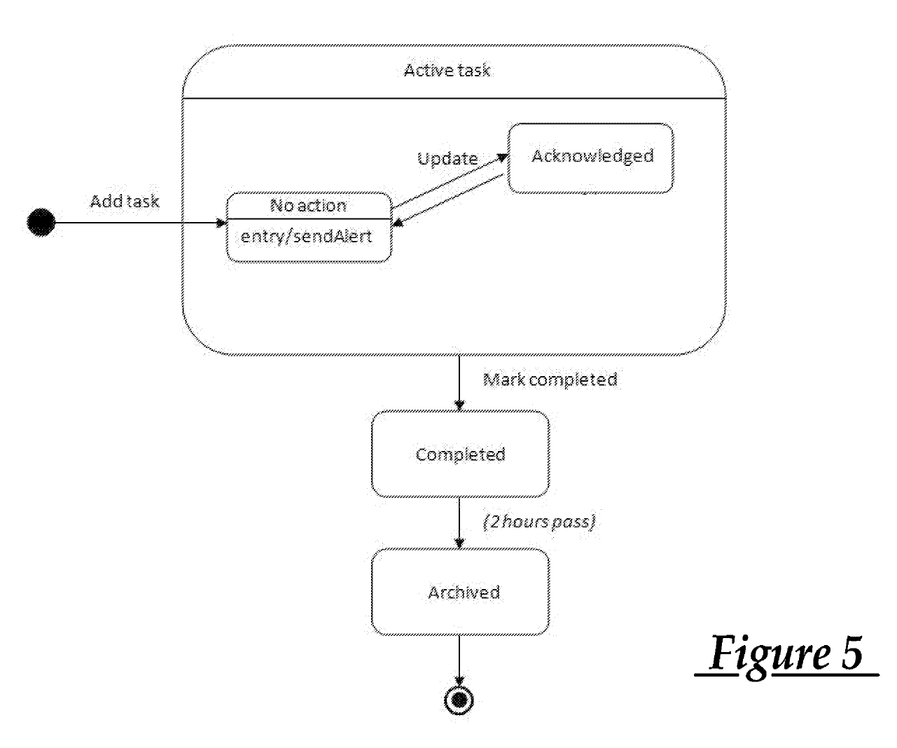

The tasks themselves have a number of possible states and transitions between states, as shown in FIG. 5. A task begins when it is created, and is initially given task status of “No action.” This triggers an alert that is sent to all users responsible for the patient. Certain properties of the alert, such as corresponding ringtones on the mobile stations, depend on whether the task is listed as high priority or low priority. However, the alert for a newly created task is sent out regardless of its priority. Once a task is created and assigned the “No action” status, users assigned to the patient associated with the task may update the task's status. Typically, a user will initially mark a task as “Acknowledged,” indicating that they plan on taking care of it in the future. These two statuses—“No action” and “Acknowledged”—are associated with active, incomplete tasks. However, a user is not forced to set a task's status along the “No action” to “Acknowledged” path. For example, a user can set an “Acknowledged” task to a status of “No Action.” Therefore, a physician who receives an emergency message may have to abandon an “Acknowledged” task that they are no longer able to commit to. It should be noted that when an “Acknowledged” task is set back to “No action,” an alert is resent to users associated with the patient in question. In another embodiment, the system can be set up so that, once acknowledged, a task cannot be set back to “No action.”

A task that is active can also be marked as completed, causing its status to be updated to “Complete.” When a task is marked complete, this action is irreversible; the task is no longer active and cannot be brought back. In other embodiments of the system, tasks marked “Completed” can be changed back to an “Acknowledged” or other status, and the system can be set up so that this reversal of status can be carried out either by the caregiver assigned to the task or by the attending physician or administrator. If desired, an “Are you sure?” screen can be included to prevent users from mistakenly marking a task as complete. All status changes made to tasks can be stored along with an identification of which user changed the status. Furthermore, if desired, certain status changes, or changes to certain tasks can be limited only to certain users, such as physicians, and this can be enforced based on the user's login to the system.

As noted previously, tasks can be archived so that, for example, after a task has been marked as “Completed” for two hours, its status can be automatically updated to “Archived.” Unlike active tasks or completed tasks, archived tasks will not show up on a patient's current task list. However, administrators and, if desired, some or all of the caregivers will retain the ability to access the full histories of all tasks, including archived tasks.

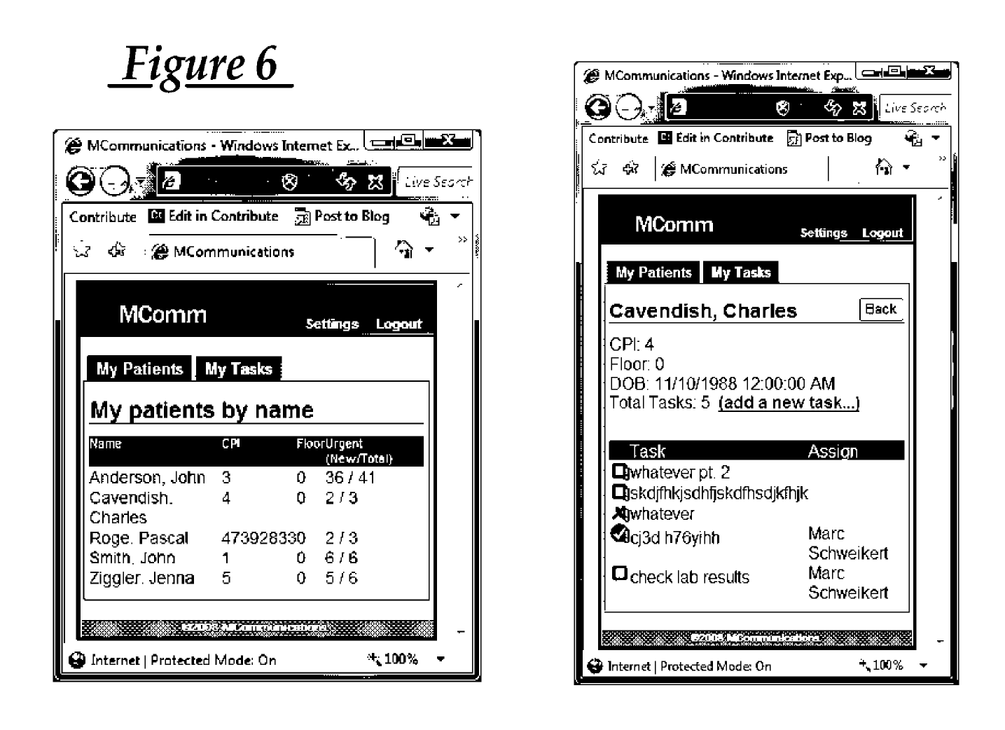

Turning now to FIGS. 6-8, the user interface for the mobile stations, computer stations and administrator access will now be described. FIG. 6 depicts two screenshots of the user interface presented on the display of the mobile stations and similar screens can be used for the computer stations. The first depicts a listing of patients associated with the practitioner carrying the mobile station, and this list is retrieved and presented to the practitioner based on their login to the system. This list of patients is selectable by the user via a “My Patients” tab on the display screen. The user can filter the list by team/service or by floor or unit of the facility or by facility (or any other relevant parameters). The list can be automatically sorted by last name or, optionally, patients with unacknowledged high priority tasks can be listed first and sorted by name. The list can include icons or other graphics to separately identify unacknowledged high priority tasks, unacknowledged low priority tasks, etc. Each patient can be selected, following which that patient's common task list is presented, as shown in the second screenshot of FIG. 6. The user can then view details of the patient, including static information such as their name and room number, and dynamic information such as a list of other caregiver's associated with the patient, their current medications, etc. The user can also view details concerning the tasks associated with the patient, for example, the message identifying the task, the task status, creator, and a log of all changes to the task status and who made the change. The user can also update the status, as discussed above.

Apart from viewing the common task list for a single patient, the user interface also includes a “My Tasks” tab that enables the practitioner to view all of the tasks for which he or she has responsibility, regardless of the patient to which it is assigned. This can help the practitioner prioritorize workflow among outstanding tasks. Apart from viewing and acting on existing tasks, the user interface on the mobile stations and computer stations can be used to create new tasks and set the priority of the associated message that is sent when that task is created. Then, all caregivers associated with the patient are notified when that task is added, with the alert being dependent on the assigned priority (e.g., vibrate for low priority, loud ring and vibrate and ring for high priority).

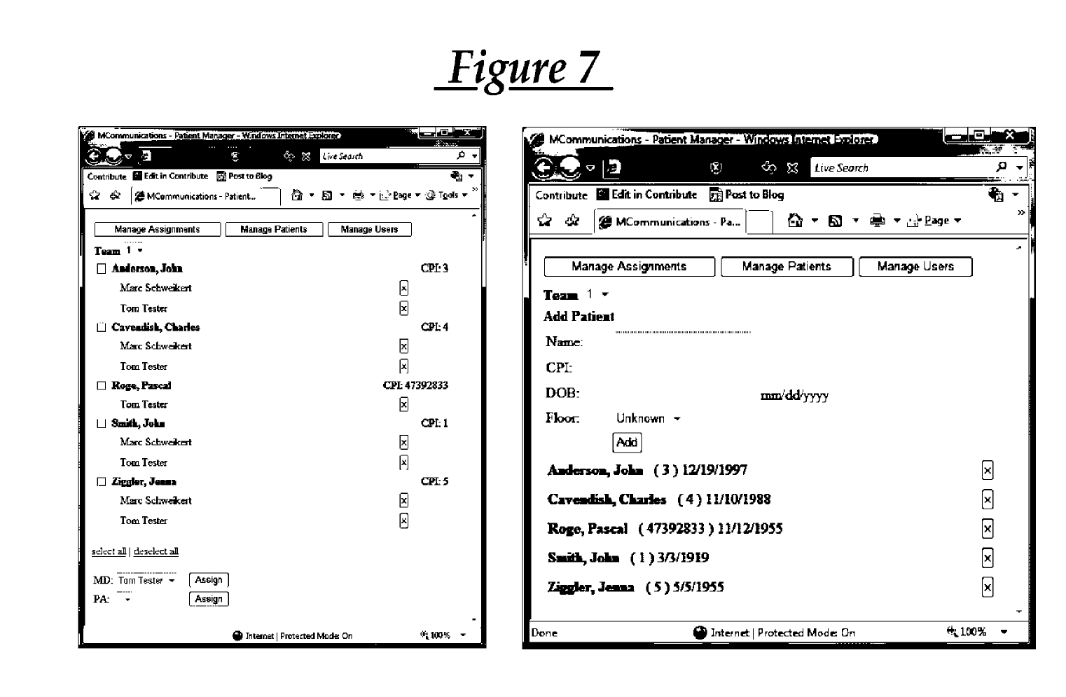

FIG. 7 depicts an exemplary user interface for use by the administrator to manage the assignment of users to the different patients or to care teams associated with a patient. The first screen of FIG. 7 shows a listing of patients and the practitioners associated with each patient. The second screen shows a list of patients and fields that the administrator can use to add new patients to the list. The administrator can also delete patients once they are discharged. In managing users, the administrator can add users and assign their access level (e.g., as caregiver or physician) as well as set and reset passwords for the users. Similarly, administrators may also delete users. Where a deleted user has open tasks assigned (e.g., that have been marked Acknowledged, but not yet marked Completed), the task can be reassigned to its original status. Also, if desired, the system can be set up so that the administrator cannot delete a user that is associated with a patient having no other associated caregivers.

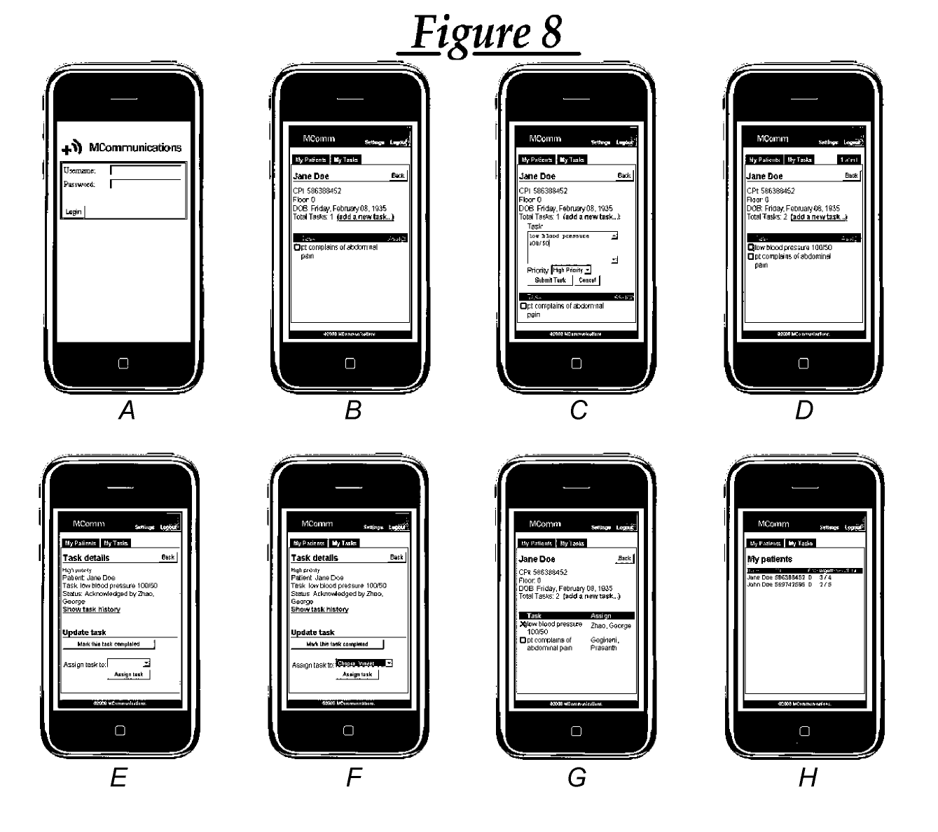

FIGS. 8A-8H depict screenshots of a user interface for the mobile stations that can be used in addition to or in lieu of that shown in FIG. 6.

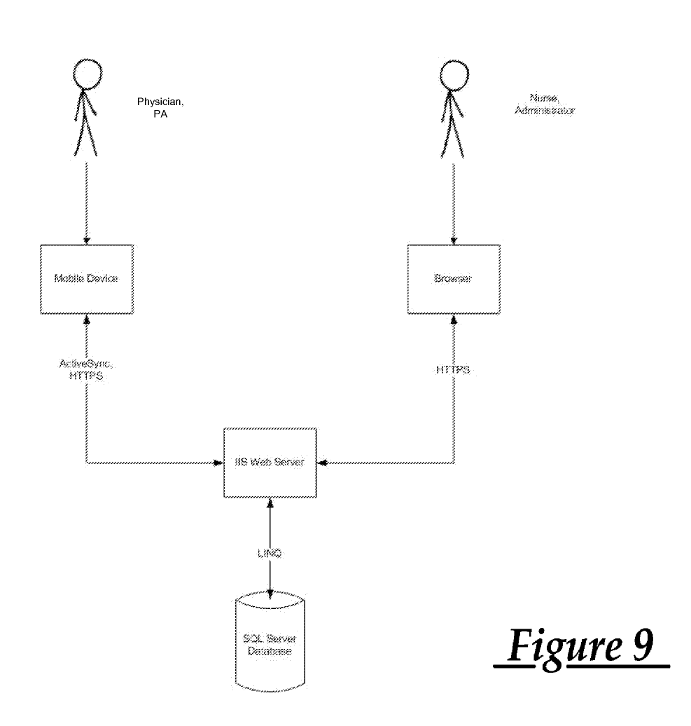

As discussed above, the entire patient, caretaker, task, and message information used by the system in carrying out the functions of the system are stored in the database. Thus, all the interactions with the system via the user interfaces of FIGS. 6-8 involve accesses to the data from the database. FIGS. 9-12 depict further detail of one exemplary implementation of the database and communication with the mobile stations and computer stations.

The medical communication system can be implemented as a web-based system using a client/server approach with a user web interface for computer stations, a mobile application and interface for mobile stations, and administrative web interface for the administrators, as discussed above. The majority of the logic is on the server side, and functionality to retrieve, insert, and update data is exposed by a secure web service. The client website and mobile application are responsible for displaying data, and calling the appropriate web service function for a given user action. However, for devices which a mobile application has not been implemented, a mobile version of the client website could be used as well, providing cross-compatibility for all devices with a web browser.

The implementation of FIGS. 9-12 utilizes the following components from Table I, and it will be appreciated that various other architectures, platforms, and development tools can be used in addition to or in lieu of these.

TABLE I

Hardware:
Web Server
2 X Apple iPhone
Development Tools (from MSDN):
VMware Virtual Server
Microsoft Server Enterprise Edition 2008 x64
Microsoft Visual Studio Professional 2008
SQL Server 2005 Developer Edition
Other Tools:
iPhone SDK

As shown in FIG. 9, the web server communicates with the mobile device or computer station over an encrypted connection using any of a number of technology approaches known to those skilled in the art. In the illustrated embodiment, the web server communicates to the database using LINQ—Language Integrated Query, although other technologies may be employed in lieu of or in addition to the aforementioned. LINQ is a feature of the .NET 3.5 Framework that allows a user to send and receive data to and from a database in an Object-Oriented way, without the user having to write any SQL queries.

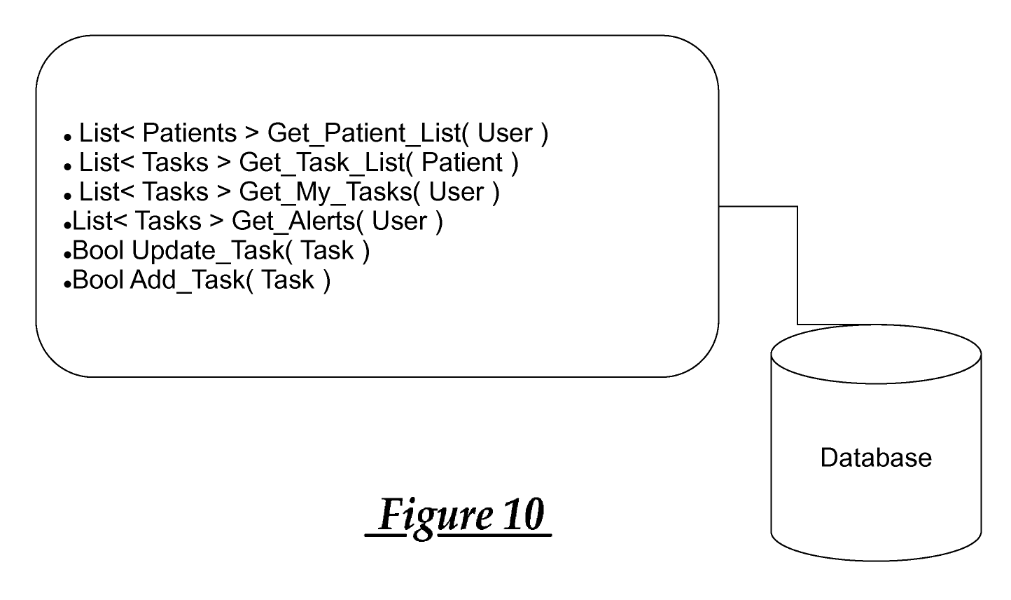

FIG. 10 depicts some of the web service functions used by the client devices to obtain patient and task information from the server. The administrative client can also interface with the data server through web service functions to carry out the functions described above in connection with FIG. 7.

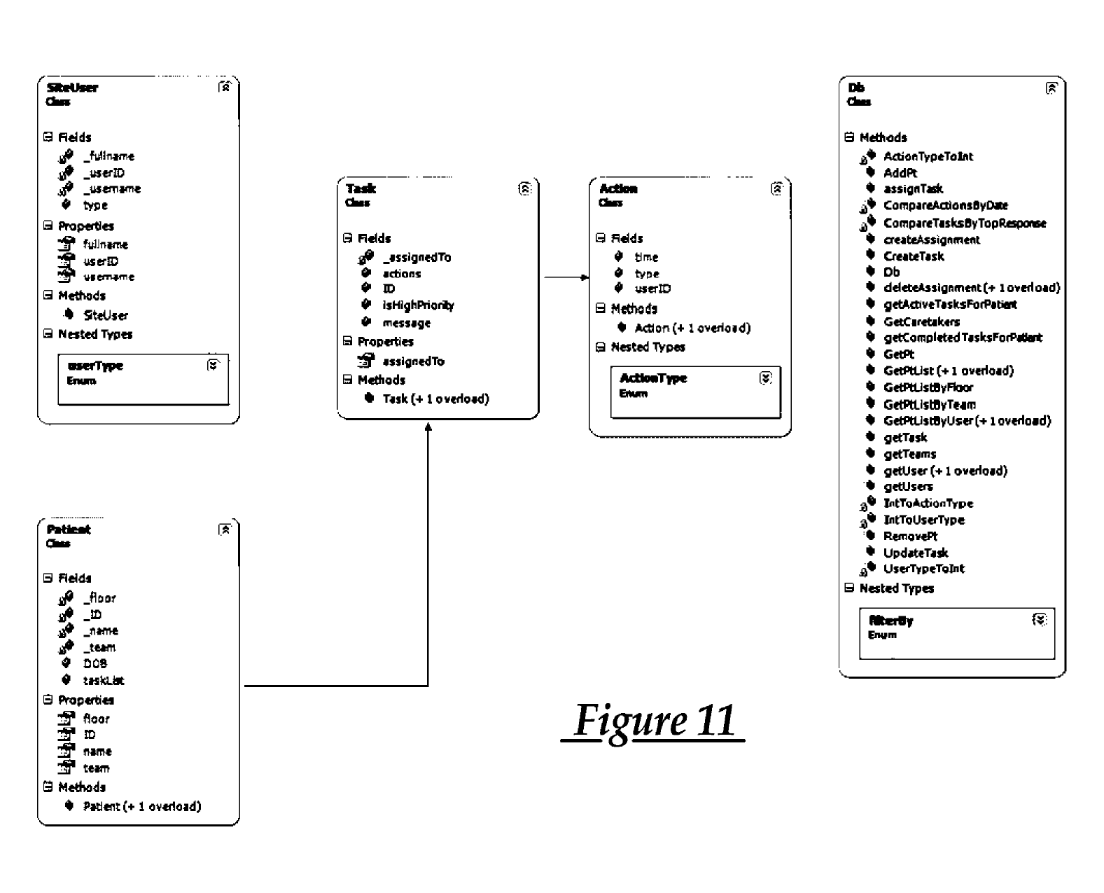

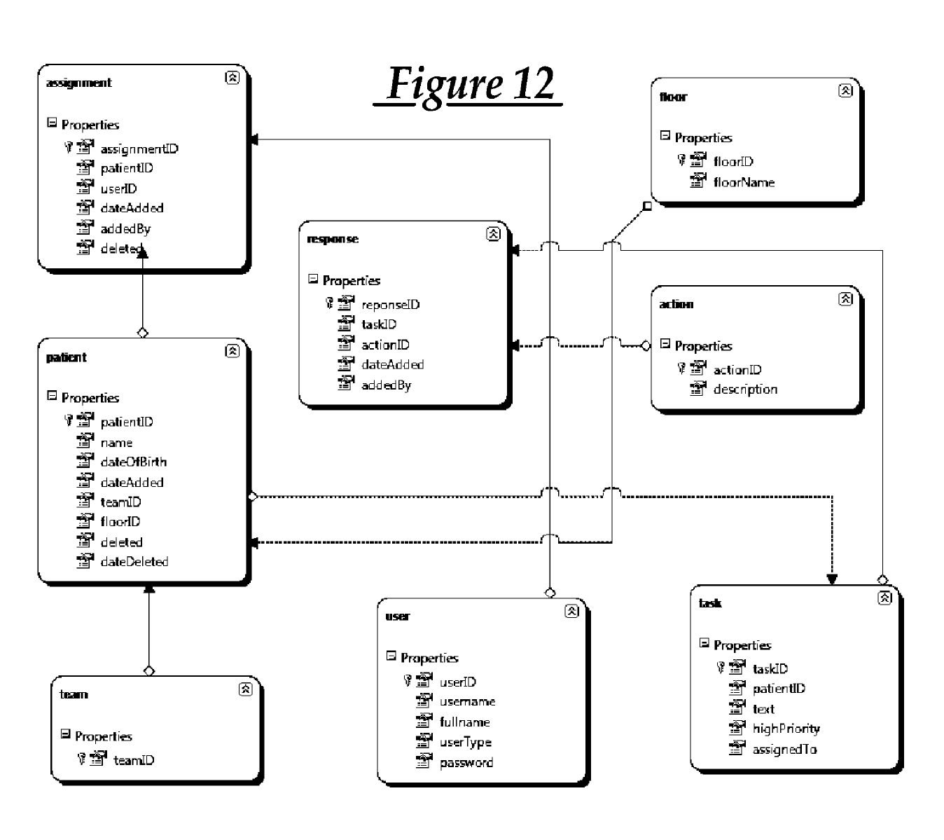

FIG. 11 depicts the class diagram of the system. All of the classes shown therein also make use of the Db class which acts as an abstraction to the database. The database schema is shown in FIG. 12 which has some of the same elements as the class diagram. In the database, the system needs to manage the assignments of tasks as well as keep track of additional information about the users and tasks. This includes information such as what teams the practitioners are assigned to, what floor the patient is located on, and how the tasks are delegated among the teams. The different database objects and their properties shown in the figures are exemplary only and the actual ones used will depend on the particular implementation and functionality desired. Similarly, with the mobile stations, task information can be pushed out to the mobile stations or they can be configured to periodically query the server for specific information. It is to be understood that the foregoing is a description of one or more preferred exemplary embodiments of the invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, rather than using a central server, each of the stations could carry the task information with changes made on one station being sent to all others carrying the task list so that each station maintains updated information. Known techniques such as for database record locking can be used to prevent simultaneous conflicting changes to task information, as will be known by those skilled in the art. This and all such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A medical communication system for use in connection with providing medical care to patients at a health care facility, comprising:
a central server;
a database accessible by the server and providing storage of task information associated with patients receiving medical care at the facility, wherein the task information comprises information associated with a task, including identification of the task, task status, task priority, task assignment or any combination of these; and
a plurality of mobile stations each carried by a health care practitioner for use within the facility, each of said mobile stations being accessible within the health care facility by the server via wireless communication;
wherein, for any particular patient, the server is operable to access task information associated with that patient from the database and send the task information to mobile stations carried by the health care practitioners associated with that patient, and wherein the server is further operable to receive task information from one of the health care practitioners via one of the mobile stations, store the received task information in the database, and provide the received task information to the mobile stations of other health care practitioners associated with that patient, whereby the mobile station of each practitioner associated with that patient can be automatically updated with new task information for the patient.

2. A medical communication system as defined in claim 1, wherein each mobile station includes a display and an application program that upon execution is responsive to communication from the server to receive task information and present the task information on the display.

3. A medical communication system as defined in claim 2, wherein the server is operable to automatically send received task information associated with a patient to the application program running on the mobile stations carried by the health care practitioners associated with that patient.

4. A medical communication system as defined in claim 1, wherein the mobile stations are operable to periodically connect to the server and request updated task information from the server.

5. A medical communication system as defined in claim 1, wherein the server is operable to send messages to the mobile stations, with each message having an associated priority and the mobile stations each being configured to signal arrival of a new message in a manner that depends upon its priority.

6. A medical communication system as defined in claim 1, wherein the server is operable to send new tasks to the mobile stations based on priority, with the mobile stations each being configured to signal arrival of the new task in a manner that depends upon its priority.

7. A medical communication system for use in connection with providing medical care to patients at a health care facility, comprising:
a central server;
a plurality of mobile stations each carried by a health care practitioner for use within the facility, each of said mobile stations being accessible within the health care facility by the server via wireless communication;
wherein the server is operable to send messages to the mobile stations, with each message having an associated priority and the mobile stations each being configured to signal arrival of a new message in a manner that depends upon its priority.

8. A medical communication system as defined in claim 7, wherein at least some of the messages each comprise task information associated with a task, the task information including identification of the task, task status, task priority, task assignment or any combination of these.

9. A medical communication system as defined in claim 7, wherein each mobile station is operable to receive input from a user of the mobile station and to send a message to the server containing the received input.

10. A medical communication system as defined in claim 7, wherein each mobile station is operable to send messages to other mobile stations within the facility via the server.

11. A medical communication system as defined in claim 10, further comprising a database that stores messages sent or received via the server, wherein messages sent to or from the server can be associated with a particular patient and stored in the database along with other messages associated with that patient.

12. A medical communication system as defined in claim 11, wherein each mobile station includes a display and is operable to present a received message on the display in response to user interaction with the mobile station and to send an acknowledgement to the server following the user interaction, and wherein the server is operable to store the acknowledgement in the database.

13. A mobile station for use in a medical communication system, comprising:
a mobile handset that includes a display; and
a program stored on the handset and operable upon execution to enable the receipt of task information, patient information, and messages from a server, and to present the received information and messages on the display in response to user interaction with the handset; and
wherein the program is further operable to identify a priority associated with received messages and signal arrival of each received message in a manner that depends on its priority.

14. A mobile station as defined in claim 13, wherein the mobile handset further comprises a cellular handset having wireless communication circuitry for cellular and wireless local area networking, and wherein the handset is programmed to receive the task information, patient information, and messages via the wireless local area networking.

15. A mobile station as defined in claim 13, wherein the program is operable to receive new task information for at least one task already stored on the handset and to update the stored task information on the handset with the received new task information, whereby task information on the handset can be updated via the server with changes made to an associated task by a health care practitioner via a second handset.
